(19) United States
(12) Patent Application Publication
(10) Pub. No.: US 2009/0216349 A1
(43) Pub. Date: Aug. 27, 2009

(54) METHOD AND SYSTEM FOR EXTENDING LIFETIME OF SENSOR NODES IN WIRELESS SENSOR NETWORK

(75) Inventors: Dae Hyung KWON, Seoul (KR); Sun Gi Kim, Seoul (KR); Kang Young Moon, Yongin-si (KR); Hyunseung Choo, Gwacheon-si (KR); Vladimir V. Shakhov, Suwon-si (KR)

Correspondence Address: THE FARRELL LAW FIRM, LLP, 290 Broadhollow Road, Suite 210E, Melville, NY, 11747, US

(73) Assignees: SAMSUNG ELECTRONICS CO., LTD., Suwon-si (KR); SUNGKYUKWAN UNIVERSITY, Seoul (KR)

(21) Appl. No.: 12/390,031

(22) Filed: Feb. 20, 2009

(30) Foreign Application Priority Data
Feb. 21, 2008 (KR) 10-2008-0015679

(51) Int. Cl. G06F 1/32; G05B 13/02

(52) U.S. Cl. 700/33; 713/310

(57) ABSTRACT

A method and system are provided that extend the lifetime of sensor nodes in a wireless sensor network while ensuring network availability. An availability level is set for ensuring network connectivity corresponding to importance of network connectedness. An operation probability that a sensor node is in operation is calculated. A total sleeping time of the sensor node is calculated that minimizes the operation probability while maintaining the availability level.

### PRIORITY

This application claims priority under 35 U.S.C. §119(a) to an application entitled “METHOD AND SYSTEM FOR EXTENDING LIFETIME OF SENSOR NODES IN WIRELESS SENSOR NETWORK” filed in the Korean Intellectual Property Office on Feb. 21, 2008 and assigned Serial No. 10-2008-0015679, the contents of which are incorporated herein by reference.

### BACKGROUND OF THE INVENTION

1. Field of the Invention

The present invention relates generally to a wireless sensor network and, more particularly, to a method and system that extend the lifetime of sensor nodes in a wireless sensor network while ensuring network availability.

2. Description of the Related Art

A wireless sensor network includes numerous sensor nodes distributed in a particular region. Each sensor node is a small wireless transceiver having a sensor collecting data and a processor processing the collected data. The wireless sensor network is a network that collects and processes data from the sensors and extracts desired information. In a wireless sensor network, numerous sensors located at a region monitor preset targets, and send monitoring data to a given node. In a sensor network, connected sensor nodes send and receive between each other collected information regarding temperature, illumination, humidity, upper nodes and a cluster header through Radio Frequency (RF) communication. Sensor networks are utilized in an increasing number of fields of applications, such as temperature monitoring in a given region, remote sensing and precise localization of earthquakes, home automation, and environmental condition monitoring.

With increased utilization, active research has been conducted on efficiency enhancement and operational cost reduction of sensor networks. For example, schemes have been developed for efficient use of battery power in sensors typically having limited resources, and for distribution of sensors or connection management of distributed sensors in consideration of energy efficiency. In particular, a universal scheme for reducing operational costs is to reduce power consumption in sensors having limited resources. In a sensor node, power consumption can be reduced through transitions between sleep mode and wakeup mode (or active mode). A sensor node in a wakeup mode can send and receive data. A sensor node in a sleep mode cannot send and receive data, and hence may degrade network performance due its inability to transmit and receive data. For this reason, many existing schemes employ a protocol that wakes up sensor nodes in a sleep mode to enable data transmission and reception. A representative example of such a scheme is Sparse Topology and Energy Management (STEM) protocol, one of Media Access Control (MAC) protocols. In the STEM protocol, a sensor node desiring to communicate sends a beacon packet (STEM-B version) or a tone signal (STEM-T version) to its neighbor node in a sleep mode. That is, the STEM protocol has two versions called STEM-B and STEM-T, where B stands for beacon and T for tone.

However, in most existing MAC protocols including the STEM protocol, the emphasis is on extending the lifetime of sensor nodes without considering network availability related to overall network performance. This may result in degradation of network reliability. In other words, while sensor nodes having long sleeping times have long lifetimes, a large number of sensor nodes in a sleep mode causes degradation of overall network availability due to a high probability of communication disruption. Hence, it is necessary to develop an adaptive protocol that focuses on both of lifetime extension and network availability enhancement, not on only one thereof.

### SUMMARY OF THE INVENTION

The present invention has been made to address at least the above problems and/or disadvantages and to provide at least the advantages described below. Accordingly, an aspect of the present invention provides a method and system that extend the lifetime of sensor nodes in a wireless sensor network.

According to one aspect of the present invention, a method of extending the lifetime of sensor nodes in a wireless sensor network is provided. An availability level for ensuring network connectivity is set corresponding to importance of network connectedness. An operation probability that a sensor node is in operation is calculated. A total sleeping time of the sensor node is computed that minimizes the operation probability while maintaining the availability level.

According to another embodiment of the present invention, a system for extending the lifetime of sensor nodes in a wireless sensor network is provided. The system includes a plurality of intermediate sensor nodes, each having a limited battery capacity, that collect data or transfer data from a neighbor node to another neighbor node. The system also includes a sink node that receives data from the intermediate sensor nodes as a destination and forwards the received data to a preset external apparatus. The system further includes a server that sets an availability level for ensuring network connectivity corresponding to importance of network connectedness, calculates an operation probability that each intermediate sensor node is in operation, and computes a total sleeping time of each intermediate sensor node that minimizes the operation probability while maintaining the availability level.

According to a further embodiment of the present invention, a system for extending the lifetime of sensor nodes in a wireless sensor network is provided. The system includes a plurality of intermediate sensor nodes, each having a limited battery capacity, that collect data or transfer data from a neighbor node to another neighbor node. The system also includes a sink node that receives data from the intermediate sensor nodes as a destination and forwards the received data to a preset external apparatus. The system further includes a server that finds an available battery capacity of the intermediate sensor nodes, and computes a battery capacity of each sensor node maximizing network connectivity under the constraint that the sum of battery capacities of the intermediate sensor nodes does not exceed the found available battery capacity.

In a feature of the present invention, as the total sleeping time of each sensor node is determined in consideration of network connectivity, the lifetime of sensor nodes can be extended while maintaining network availability. Each sensor node makes transitions between an active mode and a sleep mode under the constraint of the independently allocated total sleeping time, and hence can have a long lifetime without the need of considering interactions with neighbor nodes. Further, a complicated algorithm handling, for example, beacon messages is not used in the MAC protocol, hence the MAC protocol can be simplified.

### BRIEF DESCRIPTION OF THE DRAWINGS

The above and other aspects, features and advantages of the present invention will be more apparent from the following detailed description when taken in conjunction with the accompanying drawings, in which:

FIG. 1A is a diagram illustrating a sensor network;

FIGS. 1B to 1E are diagrams illustrating connectivity states in the sensor network of FIG. 1A;

FIG. 2 is a diagram illustrating characteristics of the lifetime of a sensor node in accordance with an embodiment of the present invention;

FIG. 3 is a diagram illustrating a sensor network for network connectivity computation, according to an embodiment of the present invention;

FIG. 4 is a flow chart illustrating a method for determining total sleeping times of sensor nodes in consideration of network connectivity, according to an embodiment of the present invention; and

FIG. 5 is a diagram illustrating another sensor network.

### DETAILED DESCRIPTION OF PREFERRED EMBODIMENTS

Preferred embodiments of the present invention are described in detail with reference to the accompanying drawings. The same or similar reference symbols are used throughout the drawings to refer to the same or similar parts. Detailed descriptions of constructions or processes known in art may be omitted to avoid obscuring the subject matter of the present invention.

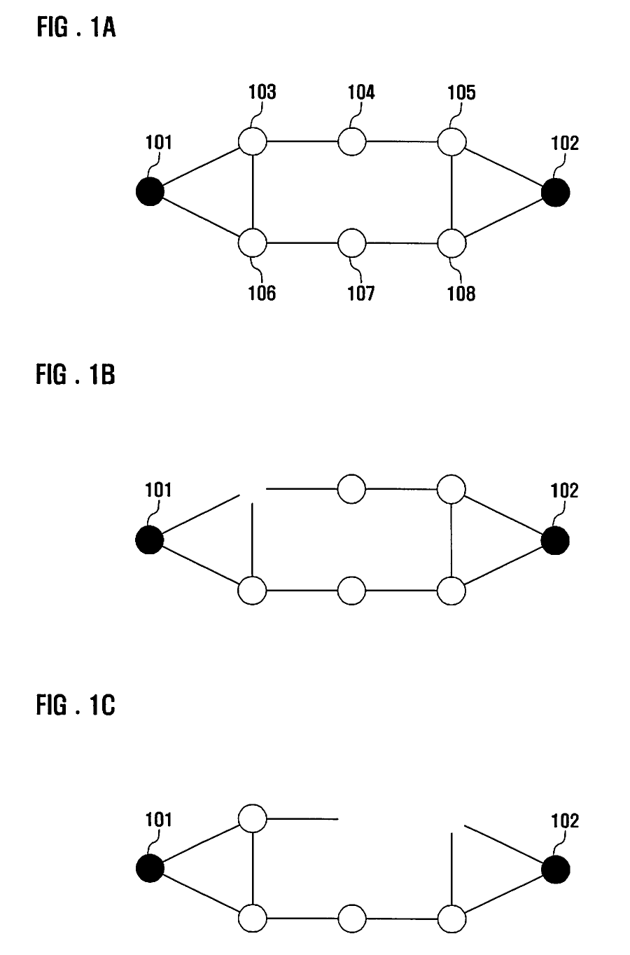

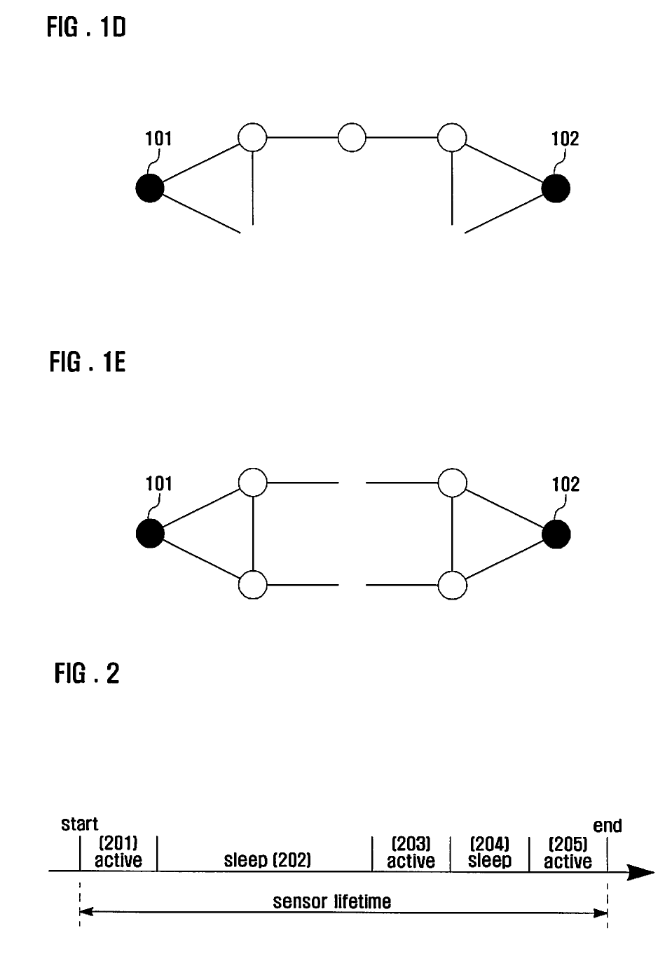

FIG. 1A illustrates a sensor network, and FIGS. 1B to 1E illustrate connectivity states in the sensor network of FIG. 1A.

In the sensor network of FIG. 1A, a sensor node 101 is a source node that collects data and sends the collected data. A sensor node 102 is a sink node that finally receives the data from the source node and sends the received data to a given external apparatus. Intermediate sensor nodes 103 to 108 relay data from the source node to the sink node. In accordance with the principles of the present invention, the sensor nodes communicate with each other while making transitions between a sleep mode (for a sleeping time) and an active mode (for an active time). In FIG. 1A, communication between the sensor node 101 and sensor node 102 can be performed through a first path of the intermediate sensor nodes 103 to 105, or through a second path of the intermediate sensor nodes 106 to 108. FIGS. 1B to 1E illustrate connectivity states of the sensor network in FIG. 1A when the intermediate sensor nodes 103 to 104 and 106 to 108 connect the sensor node 101 (source) and the sensor node 102 (sink) together.

FIG. 1B illustrate a network connectivity state when the intermediate sensor node 103 transitions to sleep mode in the sensor network of FIG. 1A. In FIG. 1B, the sensor node 101 and the sensor node 102 can be connected together through the second path of the intermediate sensor nodes 106 to 108. FIG. 1C illustrates a network connectivity state when the intermediate sensor nodes 104 and 105 transition to sleep mode in the sensor network of FIG. 1A. In FIG. 1C, the sensor node 101 and the sensor node 102 can be connected together through the second path of the intermediate sensor nodes 106 to 108. FIG. 1D illustrates a network connectivity state when the intermediate sensor nodes 106 and 108 transition to sleep mode in the sensor network of FIG. 1A. In FIG. 1D, the sensor node 101 and the sensor node 102 can be connected together through the first path of the intermediate sensor nodes 103 to 105. In addition to the network connectivity states illustrated in FIGS. 1B to 1D, many other connectivity states can result from the sensor network of FIG. 1. FIGS. 1B to 1D illustrate cases in which the network is connected through at least one path (100 percent network availability). A sensor network with 100 percent availability may require all of its sensor nodes to be operational. Because the lifetime of a fully operational sensor node without a sleeping time is determined by the battery capacity, the fully operational sensor node has a short lifetime. On the other hand, in designing a sensor network, the importance of network connectedness (data transfer reliability) should be considered. That is, a sensor network permitting no data loss may require constant network connectivity. However, in a sensor network permitting some data loss, constant network connectivity without sleeping times may cause excessive power consumption, reducing sensor lifetime. For this reason, sleeping times are employed in a sensor network. Besides those illustrated in FIGS. 1B to 1D, a network connectivity state illustrated in FIG. 1E can be generated when individual sensor nodes employ sleeping times independently. FIG. 1E illustrates a network connectivity state when the intermediate sensor nodes 104 and 107 transition to sleep mode in the sensor network of FIG. 1A. In FIG. 1E, the sensor node 101 and sensor node 102 cannot be connected together because the intermediate sensor node 104 on the first path and the intermediate sensor node 107 on the second path are in sleep mode.

As the number of times the network connectivity state as shown in FIG. 1E increases, network availability decreases. To achieve a network availability of 90 percent, sleeping times can be adjusted, in accordance with the principles of the present invention, so that the network connectivity state as shown in FIG. 1E happens about ten times out of one hundred. Similarly, to achieve a network availability of 60 percent, sleeping times can be adjusted so that the network connectivity state as shown in FIG. 1E happens about 40 times out of 100.

While extending the lifetime of sensor nodes requires long sleeping times to reduce power consumption, network connectivity requires short sleeping times. To maintain the proper balance between these two contradictory requirements, it is necessary to adjust sleeping times according to the importance of network connectedness.

FIG. 2 illustrates characteristics of the lifetime of a sensor node, according to an embodiment of the present invention.

Normally, a sensor node is driven by a limited resource, i.e., battery capacity. Referring to FIG. 2, the lifetime of a sensor node is finite, and begins at the time of operation initiation (‘start’) and ends at the time of full discharge of the battery (‘end’). The sensor node starts with active mode 201. That is, the sensor node begins to collect data or transfer data from a neighbor node to another neighbor node. After operations in active mode 201, the sensor node makes a transition to sleep mode 202. In sleep mode, a sensor node can save power, but remains in a disconnected state without being capable of communicating with neighbor nodes. After waiting in sleep mode 202, the sensor node makes a transition to active mode 203. Thereafter, the sensor node makes transitions between sleep mode and active mode until battery power is exhausted. Here, the sum of the duration of sleep mode 202 and that of sleep mode 204 is the total sleeping time of the sensor node. As described before, the lifetime of a sensor node is directly proportional to the total sleeping time. Although a long total sleeping time may extend the sensor lifetime, network connectivity must also be considered. To compute the level of network connectivity, the availability of a sensor node is defined to be the probability that the sensor node is in active mode. For the ith sensor node, the availability pᵢ can be calculated using Equation (1) on the basis of the battery capacity and total sleeping time. The sensor network is assumed to include n intermediate sensor nodes.

$${p}_{i} = \frac{{C}_{i}}{{C}_{i} + {S}_{i}} \qquad ( 1 )$$

where Cᵢ(i=1, . . . , n) denotes the battery capacity of the ith sensor node and Sᵢ(i=1, . . . , n) denotes the total sleeping time of the ith sensor node.

As described before, power consumption for driving a sensor node decreases with increasing total sleeping time. That is, when the total sleeping time becomes the maximum, the power consumption becomes the minimum. Thus, network costs can be reduced by design. However, as the total sleeping time becomes longer, the time duration when the sensor node is in active mode becomes shorter and the availability of the sensor node becomes lower. In other words, as the number of sensor nodes in sleep mode (incapable of communication) becomes larger, the level of network connectivity becomes lower. From this perspective, the present invention provides, not a scheme extending only the lifetime of sensor nodes, but also a scheme extending the lifetime of sensor nodes while maintaining a desired level of network connectivity. On the basis of the inverse proportion between total sleeping times and availabilities of sensor nodes, the network connectivity R can be calculated using Equation (2).

$${\sum }_{i = 1}^{n} {S}_{i} \to max , R ( {S}_{l} , … , {S}_{n} ) \geq α \qquad ( 2 )$$

where Sᵢ(i=1, . . . , n) denotes the total sleeping time of the ith sensor node, R(S₁, . . . , Sₙ) denotes the network connectivity in terms of total sleeping times of n sensor nodes, and α is a desired network availability.

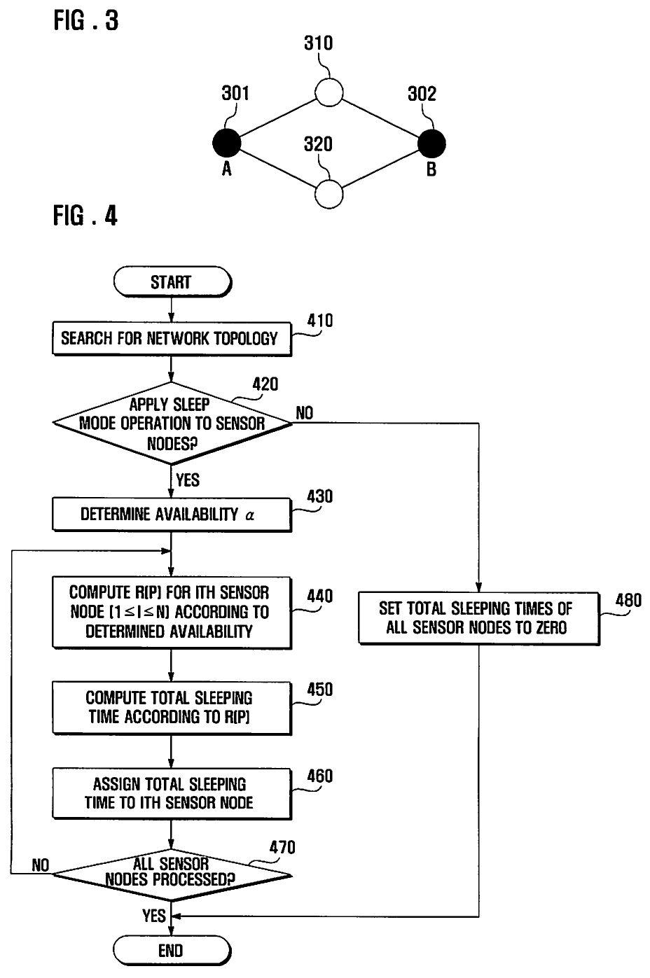

Based on Equation (2), the lifetime of sensor nodes can be effectively extended while ensuring a desired level of network connectivity by increasing the total sleeping times of the sensor nodes. Here, the network connectivity R denotes the probability that selected sensor nodes are connected together in a sensor network. That is, it indicates the probability that a source node attempting to send collected data is connected to a sink node being the final destination of the collected data. Next, computation of the network connectivity R using the law of total probability is described in connection with FIG. 3.

FIG. 3 illustrates a sensor network for network connectivity computation, according to an embodiment of the present invention. To illustrate simplified computation of the network connectivity R, the sensor network in FIG. 3 includes only two intermediate sensor nodes 310 and 320 on first and second paths connecting a sensor node 301 (source) and a sensor node 302 (sink or destination) together. In the following description, although computation of the network connectivity R with respect to the intermediate sensor node 320 is illustrated, computation thereof with respect to the intermediate sensor node 310 can be carried out in the same manner. The same procedure can also be applied to other sensor networks different from one illustrated in FIG. 3.

The sensor node 301 and the sensor node 302 can be connected together through the intermediate sensor node 310 or through the intermediate sensor node 320. Network connectivity with respect to the intermediate sensor node 320 can be considered under the condition that the intermediate sensor node 310 is available or not available. When the intermediate sensor node 310 is available, the network is connected regardless of the availability of the intermediate sensor node 320. When the intermediate sensor node 310 is not available, the intermediate sensor node 320 must be available for network connectedness. This analysis can be expressed in Equation (3).

R(p)=p×1+(1−p)p (3)

where p denotes the availability of a sensor node and R(p) denotes the network connectivity at p.

Next, computation of total sleeping times of sensor nodes is described in consideration of the network connectivity.

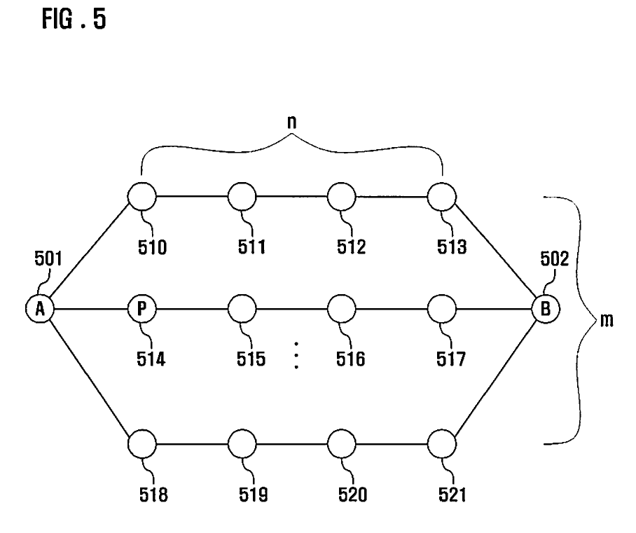

FIG. 4 is a flow chart illustrating a method for determining total sleeping times of sensor nodes in consideration of network connectivity, according to an embodiment of the present invention.

In the present invention, sensor nodes make transitions between an active mode and a sleep mode independently without interactions with their neighbor nodes through special MAC protocol signals such as beacon messages. That is, after total sleeping times are assigned to sensor nodes by a particular apparatus, each node chooses to transition between active mode and sleep mode under the condition that the sum of sleeping times in sleep mode is less than or equal to the assigned total sleeping time. In addition, the particular apparatus is assumed to be a server (not shown) that is located outside the sensor network and is connected to the sensor network to receive data from the sink node. To be more specific, the server aware of locations of the sensor nodes uses an embedded random number generator to generate total sleeping times, and assigns the total sleeping times to the sensor nodes. The embedded random number generator includes a random number generation program, and computes the total sleeping times for the sensor nodes through random number generation. Although it is described above that total sleeping times are computed and assigned by the server, in the case when each sensor node includes a random number generation program, the sensor node can directly compute the total sleeping time.

Referring to FIG. 4, the server searches for the network topology of the sensor network including distributed sensor nodes in step S410. At this step, one of many existing algorithms can be used to obtain the network topology indicating routes from the source node to the destination node. The server obtains information on available resources of the sensor nodes like battery capacities. The server determines whether to apply a sleep mode operation to the sensor nodes in step S420. If sleep mode operation is applied, the server sets a desired network availability a in step S430. The desired network availability is selected according to importance of network connectedness, and can be set to a value between zero (0) and one (1). The desired network availability is set to a large value for a sensor network whose importance of network connectedness is high, and network availability 1 is given to a sensor network whose availability is 100 percent. The server calculates the network connectivity R(p) with respect to the ith sensor node (i from 1 to n, n: the number of sensor nodes in the sensor network), using Equation 2 and Equation 3 in step S440.

The server computes the total sleeping time of the ith sensor node on the basis of R(p) in step S450. A procedure computing the total sleeping time is described below in connection with FIG. 5.

FIG. 5 illustrates a sensor network according to an embodiment of the present invention.

In the sensor network of FIG. 5, sensor nodes 501 and 502 act as sink nodes, and sensor nodes 510 to 521 are intermediate nodes connecting the sink nodes together. For the purpose of description, the intermediate sensor nodes 510 to 521 are assumed to be homogeneous sensors having the same battery capacity C. When the sleep mode operation is not applied to a sensor node, the lifetime T of the sensor node is equal to the duration due to the battery capacity C. When the sleep mode operation is applied to a sensor node, the extended lifetime T_{NEW} of the sensor node is equal to the sum of the duration due to the battery capacity C and the total sleeping time S. While the battery capacity C can be considered as fixed, it is necessary to maximize the total sleeping time S to extend the sensor lifetime. However, as described before, the total sleeping time S cannot become arbitrary longer because of a desired level of network availability.

For a sensor node, when the total sleeping time S is maximized, the availability p of the sensor node (the probability that the sensor node is in active mode) is minimized. In this case, if the network connectivity, the probability that the sensor nodes 501 and 502 are connected together, is set to α, then a relation given in Equation (4) holds.

p→min, R(p)≧α (4)

where p denotes the availability of the sensor node, R(p) denotes the network connectivity at p, and a is a desired network availability.

With minimized p, as R(p) is greater than or equal to α, Equation 4 can be reduced to Equation (5).

R(pₘᵢₙ)=α (5)

where p denotes the availability of the sensor node, R(p) denotes the network connectivity at p, and α is a network availability.

By applying the law of total probability, which breaks down the computation of a probability into distinct cases, to the sensor network of FIG. 5, the network connectivity R(p) can be computed as shown in Equation (6).

R(p)=1−(1−pⁿ)^{m} (6)

Here, Equation (6) can be reduced to Equation (7) using Equation (5).

1−(1−pₘᵢₙⁿ)^{m}=α (7)

Using Equation (5) and the homogeneity assumption of the same battery capacity, Equation (1) can be rewritten as Equation (8).

$${p}_{mi n} = \frac{C}{C + {S}_{max}} \qquad ( 8 )$$

where C denotes the battery capacity of the sensor node, Sₘₐₓ the maximum of the total sleeping time, and pₘᵢₙ denotes the minimum of the availability.

From Equation (8), the maximum of the total sleeping time Sₘₐₓ can be obtained as in Equation (9).

$${S}_{max} = ( \frac{1}{{p}_{max}} - 1 ) C \qquad ( 9 )$$

The total sleeping time can be computed using Equation (1) to Equation (9) in consideration of a desired level of network availability. The lifetime of the sensor node can be extended by applying the computed total sleeping time to the sensor node, in which case the extended lifetime T_{new} can be expressed using Equation (10).

$${T}_{new} = C + {S}_{max} = \frac{C}{{p}_{min}} \qquad ( 10 )$$

Next, sensor lifetime extension is illustrated through examples with and without application of the sleep mode operation.

As an example, assume that m is 20, n is 2, α is 0.9, and C is 100 hours for the sensor node in FIG. 5. When the sleep mode operation is not applied, as the lifetime T of an intermediate sensor node is the duration due to the battery capacity C, T is 100 hours. When the sleep mode operation is applied, the new lifetime T_{new} of an intermediate sensor node is computed to be 303.2 hours using Equation (7) and Equation (10). This illustrates sensor lifetime extension.

As another example, assume that m is 20, n is 2, α is 0.3, and C is 100 hours for the sensor node in FIG. 5. In the case when the sleep mode operation is not applied, as the lifetime T of an intermediate sensor node is the duration due to the battery capacity C, T is 100 hours. In the case when the sleep mode operation is applied, the new lifetime T_{new} of an intermediate sensor node is computed to be 752.2 hours using Equation (7) and Equation (10). Compared with the above example (α=0.9), the lifetime of an intermediate sensor node is very significantly extended. This is because the intermediate sensor node remains in sleep mode for a longer time.

Although the total sleeping time is computed under the assumption that intermediate sensor nodes have the same battery capacity, the total sleeping time and extended lifetime of an intermediate sensor node can also be computed similarly when intermediate sensor nodes have different battery capacities.

Referring back to FIG. 4, the server assigns the computed total sleeping time to the total sleeping time of the ith sensor node in step S460. The server checks whether all the sensor nodes are processed in step S470. For checking, the server can compare the sequence number of the current sensor node with n. If all the sensor nodes are processed, the server terminates computation of total sleeping times. If all the sensor nodes are not processed, the server returns to step S440 for computing the total sleeping time of the next sensor node.

If sleep mode operation is not applied at step S420, the server sets the total sleeping times of all the sensor nodes to zero in step S480. In this case, the lifetime T of each sensor node is the same as the duration due to the battery capacity C.

As described above, in the embodiments of the present invention, total sleeping times of sensor nodes are determined in consideration of network connectivity, and each sensor node makes transitions between active mode and sleep mode under the constraint of the assigned total sleeping time. Thereby, the lifetime of sensor nodes can be extended while maintaining a desired level of network availability without consideration of interactions with neighbor nodes or without use of a complicated MAC protocol algorithm.

Hereinabove, total sleeping times of sensor nodes are adjusted while battery capacities thereof are fixed. For more efficiency, both total sleeping times and battery capacities of sensor nodes can be adjusted using Equation (11).

$${\sum }_{i = 1}^{n} ( {S}_{i} + {C}_{i} ) \to max , R ( {S}_{1} , … , {S}_{n} ; {C}_{1} , … , {C}_{n} ) \geq α \qquad ( 11 )$$

where Sᵢ(i=1, . . . , n) denotes the total sleeping time of the ith sensor node, Cᵢ(i=1, . . . , n) denotes the battery capacity of the ith sensor node, R(S₁, . . . , Sₙ; C₁, . . . , Cₙ) denotes the network connectivity in terms of total sleeping times and battery capacities of n sensor nodes, and α is a desired network availability.

Equation (11) is similar to Equation (2) considering only total sleeping times. In a manner similar to computation of total sleeping times of sensor nodes using Equation (2), total sleeping times and battery capacities of sensor nodes can be computed using Equation (11), and a description of this computation is omitted.

In the above description, total sleeping times of sensor nodes are computed after a level of network availability is set. Instead of setting a desired level of network availability in advance, network connectivity can be maximized as long as resources of sensor nodes such as battery capacities permit.

$$R \to max , {\sum }_{i = 1}^{n} {C}_{i} \leq A \qquad ( 12 )$$

where R denotes the network connectivity, Cᵢ(i=1, . . . , n) denotes the battery capacity of the ith sensor node, and A denotes the available resource of sensor nodes.

As shown in Equation (12), when resources available to sensor nodes are given, by computing battery capacities Cᵢ of the sensor nodes under the constraint that the sum of battery capacities Cᵢ does not exceed the given resources, a sensor network can be configured to provide a maximized network connectivity under the resource constraint. Using a relation as shown in Equation (12), the present invention enables derivation of a sensor network configuration having a maximized network connectivity under the resource constraint without pre-setting a network availability.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of extending the lifetime of sensor nodes in a wireless sensor network, comprising the steps of:
setting an availability level for ensuring network connectivity corresponding to importance of network connectedness;
calculating an operation probability that a sensor node is in operation; and
computing a total sleeping time of the sensor node that minimizes the operation probability while maintaining the availability level.

2. The method of claim 1, wherein the operation probability is computed by dividing a duration due to a battery capacity of the sensor node by a sum of the duration and a total sleeping time of the sensor node.

3. The method of claim 2, wherein the importance of network connectedness corresponds to an importance of data transmission through the sensor network, and a high level of network connectedness corresponds to a high level of network connectivity.

4. The method of claim 3, wherein the availability level is a value between 0 to 1 depending on importance of network connectedness, and an availability level of 1 indicates 100 percent network connectivity.

5. The method of claim 4, wherein the lifetime of the sensor node extends as the total sleeping time becomes longer.

6. The method of claim 5, wherein the total sleeping time is the sum of sleeping times in sleep mode until the battery capacity of the sensor node is exhausted, and transitions between an active mode and a sleep mode are independently made by the sensor node.

7. The method of claim 6, wherein computing a total sleeping time comprises calculating the network connectivity by making a network connectivity with respect to a minimum of the operation probability equal to a set availability level.

8. The method of claim 7, wherein the network connectivity is a probability that a source node sending collected data is connected to a destination node finally receiving the data in the sensor network.

9. The method of claim 1, wherein computing a total sleeping time comprises calculating a battery capacity of the sensor node that minimizes the operation probability while maintaining the availability level.

10. A method of extending a sensor node lifetime in a wireless sensor network having a plurality of sensor nodes, comprising the steps of:
finding an available battery capacity of the sensor nodes; and
computing a battery capacity of each sensor node maximizing network connectivity under a constraint that a sum of battery capacities of the sensor nodes does not exceed the found available battery capacity.

11. A system for extending the lifetime of sensor nodes in a wireless sensor network, comprising:
a plurality of intermediate sensor nodes, each having a limited battery capacity, that collect data or transfer data from a neighbor node to another neighbor node;
a sink node that receives data from the intermediate sensor nodes as a destination and forwards the received data to a preset external apparatus; and
a server that sets an availability level for ensuring network connectivity corresponding to importance of network connectedness, calculates an operation probability that each intermediate sensor node is in operation, and computes a total sleeping time of each intermediate sensor node that minimizes the operation probability while maintaining the availability level.

12. The system of claim 11, wherein the server computes the operation probability of an intermediate sensor node by dividing a duration due to the battery capacity of the intermediate sensor node by the sum of a duration and a total sleeping time of the intermediate sensor node.

13. The system of claim 12, wherein the importance of network connectedness corresponds to an importance of data transmission through the sensor network, and a high level of network connectedness corresponds to a high level of network connectivity.

14. The system of claim 13, wherein the availability level is a value between 0 to 1 depending on importance of network connectedness, and an availability level of 1 indicates 100 percent network connectivity.

15. The system of claim 14, wherein the lifetime of an intermediate sensor node extends as the total sleeping time thereof becomes longer.

16. The system of claim 15, wherein the total sleeping time of an intermediate sensor node is a sum of sleeping times in sleep mode until the battery capacity of the intermediate sensor node is exhausted.

17. The system of claim 16, wherein each intermediate sensor node independently makes transitions between an active mode and a sleep mode so that the sum of sleeping times in sleep mode is equal to the total sleeping time.

18. The system of claim 17, wherein the server computes the total sleeping time of an intermediate sensor node after calculating the network connectivity by making a network connectivity with respect to the minimum of the operation probability equal to a set availability level.

19. The system of claim 18, wherein the network connectivity is a probability that a source node sending collected data is connected through the intermediate sensor nodes to the sink node.

20. The system of claim 12, wherein the server computes the total sleeping time and battery capacity of an intermediate sensor node that minimizes the operation probability while maintaining the availability level.

21. A system for extending the lifetime of sensor nodes in a wireless sensor network, comprising:
a plurality of intermediate sensor nodes, each having a limited battery capacity, that collect data or transfer data from a neighbor node to another neighbor node;
a sink node that receives data from the intermediate sensor nodes as a destination and forwards the received data to a preset external apparatus; and
a server that finds an available battery capacity of the intermediate sensor nodes, and computes a battery capacity of each sensor node maximizing network connectivity under a constraint that a sum of battery capacities of the intermediate sensor nodes does not exceed the found available battery capacity.
